(19) United States
(12) Patent Application Publication
(10) Pub. No.: US 2004/0221068 A1
(43) Pub. Date: Nov. 4, 2004

(54) System for controlling input/output of network office equipment

(76) Inventors: Takayuki Ohta, Kanagawa (JP); Koji Shimizu, Kanagawa (JP)

Correspondence Address: Jonathan P. Osha, Rosenthal & Osha L.L.P., Suite 2800, 1221 McKinney St., Houston, TX, 77010, US

(21) Appl. No.: 10/616,316

(22) Filed: Jul. 9, 2003

(30) Foreign Application Priority Data
Apr. 30, 2003 (WO) PCT/JP03/05510

(51) Int. Cl. G06F 3/00

(52) U.S. Cl. 710/1

(57) ABSTRACT

When an output demand for a document, drawing, or the like is given to a printer 1 for common use from a personal computer 2 which is LAN-connected, a list of documents, drawing, or the like stored in the printer 1 is displayed in a display section 2a of the personal computer 2 based on data transmitted from the printer 1, and when the document, drawing, or the like for which the output demand is given requires authentication by means of a password or the like, the document, drawing, or the like is outputted from the printer 1 only when an authentication process is normally made by the input of a proper password.

### BACKGROUND OF THE INVENTION

1. Field of the Invention

The present invention relates to an input/output control method in a system for controlling input/output of network office equipment represented by printers, facsimile machines, and the like, and to the system for controlling input/output of network office equipment.

2. Description of the Related Art

Many computer networks, for example, LAN (Local Area Network) and so on have been conventionally so configured that a printer is shared by a plurality of client terminals. In such a configuration, when a person concerned with a document, drawing, or the like that should not be seen by people other than those concerned (hereinafter, referred to as a confidential document, drawing, or the like’), if there is any stored in a client terminal, gives a print command of the document, drawing, or the like to the printer, the person concerned only needs to promptly get to the place where the printer is in order to avoid inadvertently allowing a person other than those concerned to see the document, drawing, or the like outputted from the printer.

However, print execution of such a confidential document, drawing, or the like is possible even when a person other than those concerned operates a client terminal which has edited the confidential document, drawing, or the like in the absence of those concerned, resulting in insufficient confidentiality of the confidential document, drawing, or the like in such a case, and there exists a demand for preventing such a situation from occurring.

Further, since it is not always necessary to print the entire document, drawing, or the like and in some cases, only a part thereof is required, regardless of whether or not it is a confidential document, drawing, or the like, there is also a demand for outputting only a necessary part to prevent useless output as much as possible.

### SUMMARY OF THE INVENTION

It is an object of the present invention to provide an input/output control method in a system for controlling input output of network office equipment and the system for controlling input/output of network office equipment which are so configured that only a person concerned is allowed to output a confidential document, drawing, or the like to ensure sufficient confidentiality.

It is another object of the present invention to provide an input/output control method in a system for controlling input/output of network office equipment and the system for controlling input/output of network office equipment which are so configured that output of only a necessary document, drawing, or the like is possible to avoid useless output.

According to a first aspect of the present invention, provided is an input/output control method in a system for controlling input/output of network office equipment including a plurality of computers and a network office equipment to constitute a network, the method including:

displaying a list of output objects stored in the network office equipment to allow selection of an output object from the list when an output demand is given to the network office equipment.

According to a second aspect of the present invention, provided is a computer program product for controlling input/output of network office equipment executed in a network office equipment in a system for controlling input/output of network office equipment, the system including a plurality of computers and the network office equipment to form a network, and the computer program product including:

program code means for executing an output demand acceptance step of accepting an output demand to the network office equipment;

program code means for executing a list display step of displaying a list of output objects stored in the network office equipment when the output demand is accepted;

program code means for executing an output object specifying step of specifying an output object for which the output demand is given; and

program code means for executing an output step of outputting the output object specified in the output object specifying step.

According to a third aspect of the present invention, provided is a system for controlling input/output of network office equipment, the system including a plurality of computers and a network office equipment to form a network, and the system being so configured:

that the network office equipment enables a list of output objects stored in the network office equipment to be displayed when receiving an output demand; and

that, when an output object is specified, the network office equipment judges whether or not the output object requires an authentication process and allows the output object that is judged to require the authentication process to be outputted only when the authentication process is normally made.

According to a fourth aspect of the present invention, provided is a network office equipment that is used in a system for controlling input/output of network office equipment, the system including a plurality of computers and a network office equipment to form a network, and the network office equipment being so configured:

that the network office equipment enables a list of output objects stored in the network office equipment to be displayed when receiving an output demand; and

that, when an output object is specified, the network office equipment judges whether or not the output object requires an authentication process and allows the output object that is judged to require the authentication process to be outputted only when the authentication process is normally made.

### BRIEF DESCRIPTION OF THE DRAWINGS

FIG. 1 is a block diagram showing a first configuration example of a system for controlling input/output of network office equipment according to an embodiment of the present invention;

FIG. 2 is a subroutine flowchart showing a process procedure of input/output control executed in a personal computer constituting the system for controlling input/output of network office equipment shown in FIG. 1;

FIG. 3 is a schematic view schematically showing an example of list display;

FIG. 4 is a flowchart showing a process procedure of input/output control executed in a printer constituting the system for controlling input/output of network office equipment shown in FIG. 1;

FIG. 5 is a flowchart showing a time process procedure;

FIG. 6 is a flowchart showing a process procedure in the personal computer when living body information is used for outputting a document, drawing, or the like;

FIG. 7 is a flow chart showing a process procedure in a network office equipment when the living body information is used for outputting a document, drawing, or the like;

FIG. 8 is a flowchart showing a process procedure in the personal computer when an IC card is used for outputting a document, drawing, or the like;

FIG. 9 is a flowchart showing a process procedure in the network office equipment when the IC card is used for outputting a document, drawing, or the like;

FIG. 10 is a block diagram showing a second configuration example of a system for controlling input/output of network office equipment in an embodiment of the present invention;

FIG. 11 is a block diagram showing a third configuration example of a system for controlling input/output of network office equipment in an embodiment of the present invention;

FIG. 12 is a subroutine flowchart showing a process procedure of input/output control executed in a personal computer connected to a transmitting-side facsimile machine constituting the system for controlling input/output of network office equipment shown in FIG. 11;

FIG. 13 is a flowchart showing a process procedure of input/output control executed in the transmitting-side facsimile machine constituting the system for controlling input/output of network office equipment shown in FIG. 11;

FIG. 14 is a subroutine flowchart showing a process procedure of input/output control executed in a personal computer connected to a receiving-side facsimile machine constituting the system for controlling input/output of network office equipment shown in FIG. 11;

FIG. 15 is a flowchart showing a process procedure of input/output control executed in the receiving-side facsimile machine constituting the system for controlling input/output of network office equipment shown in FIG. 11;

FIG. 16 is a block diagram showing a fourth configuration example of a system for controlling input/output of network office equipment in an embodiment of the present invention;

FIG. 17 is a subroutine flowchart showing a process procedure of input/output control executed in a personal computer constituting the system for controlling input/output of network office equipment shown in FIG. 16;

FIG. 18 is a subroutine flowchart showing a process procedure of input/output control executed in an image scanner constituting the system for controlling input/output of network office equipment shown in FIG. 16; and

FIG. 19 is a subroutine flowchart showing a process procedure of input/output control executed by a network office equipment when the operation in the network office equipment causes output to be executed.

### DETAILED DESCRIPTION OF THE PREFERRED EMBODIMENTS

Hereinafter, the present invention will be explained in detail with reference to the attached drawings.

It is to be understood that the members, arrangement, and so on explained below are not to limit the present invention, and various changes and modifications can be made within the sprit and scope of the present invention.

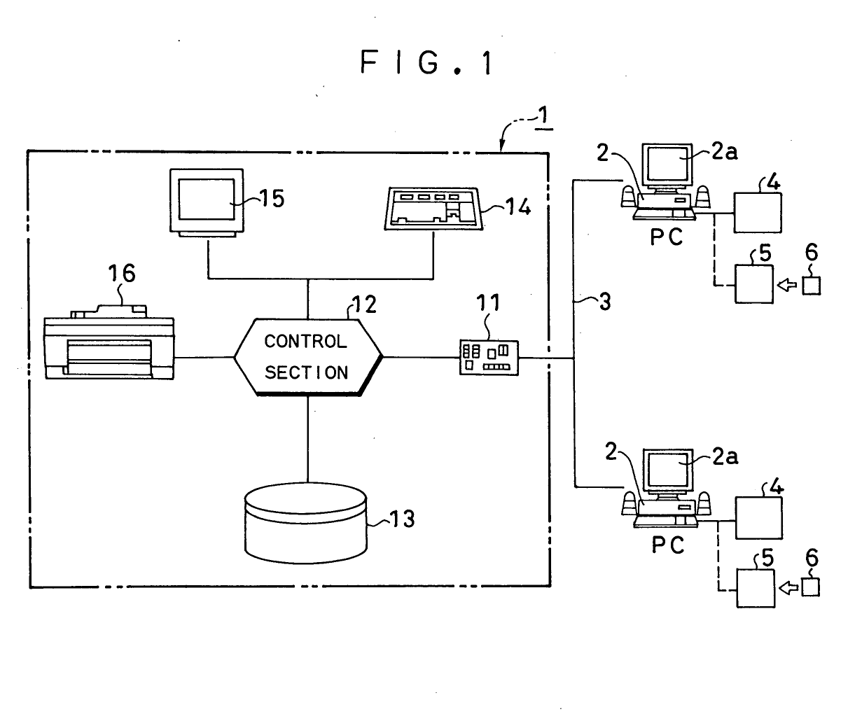

To begin with, a first configuration example of a system for controlling input/output control of network office equipment in an embodiment of the present invention will be explained with reference to FIG. 1.

A system S1 for controlling input/output of network office equipment in this first configuration example is an example when it is applied to a computer network, and as a concrete example of the computer network here, a LAN (Local Area Network) or the like is suitable.

This system S1 for controlling input/output of network office equipment is so configured that, first, a plurality of computers, concretely, for example, personal computers (denoted by ‘PC’ in FIG. 1) 2 having a structure well-known in the art are connected to each other via, for example, a LAN cable 3 to constitute a LAN.

A printer 1 for common use is connected to this LAN cable 3.

Another possible configuration is that living body information reading units 4 are connected to the plural personal computers 2 respectively, thereby enabling management of printed documents, drawings, and so on by way of fingerprints or the like instead of passwords, as will be described later.

Still another possible configuration is that IC card reading units 5 for reading data on IC cards 6 are connected to the plural personal computers 2 respectively to enable management of printed documents, drawings, and so on by way of the IC cards 6 instead of passwords.

A printer 1 as a network office equipment in this embodiment is composed of a network interface 11, a control section 12, a storage unit 13, an operation section 14, a display section 15, and an output section 16 as its main constituent elements.

The network interface 11 has a structure well-known in the art for interfacing with the plural personal computers 2 which are LAN-connected, thereby enabling mutual data exchange between the printer 1 and the plural personal computers 2.

The control section 12 controls the operation of the whole printer 1 so as to cause input/output control processes as will be described later to be executed. The control section 12 thus configured is realized by, for example, a microcomputer and software, and the one thus constituted is suitable.

The storage unit 13 stores therein control programs executed in the control section 12 and various kinds of data, and concrete examples usable as the storage unit 13 are various kinds of storage mediums well-known in the art such as a so-called magnetic recording medium, magneto-optic storage medium, semiconductor storage medium, for example, a hard disk (HDD), a magneto-optic disk, and the like.

The operation section 14 includes various kinds of operation keys and a ten-key pad which are necessary when the selection of an object to be printed and so on are all performed in this printer 1 instead of being instructed from each of the personal computers 2 as will be described later.

The display section 15 has a structure well-known in the art for list display and the like of documents, drawings, or the like to be printed which are stored in this printer 1.

The output section 16 has a structure well-known in the art for printing and outputting documents, drawings, or the like.

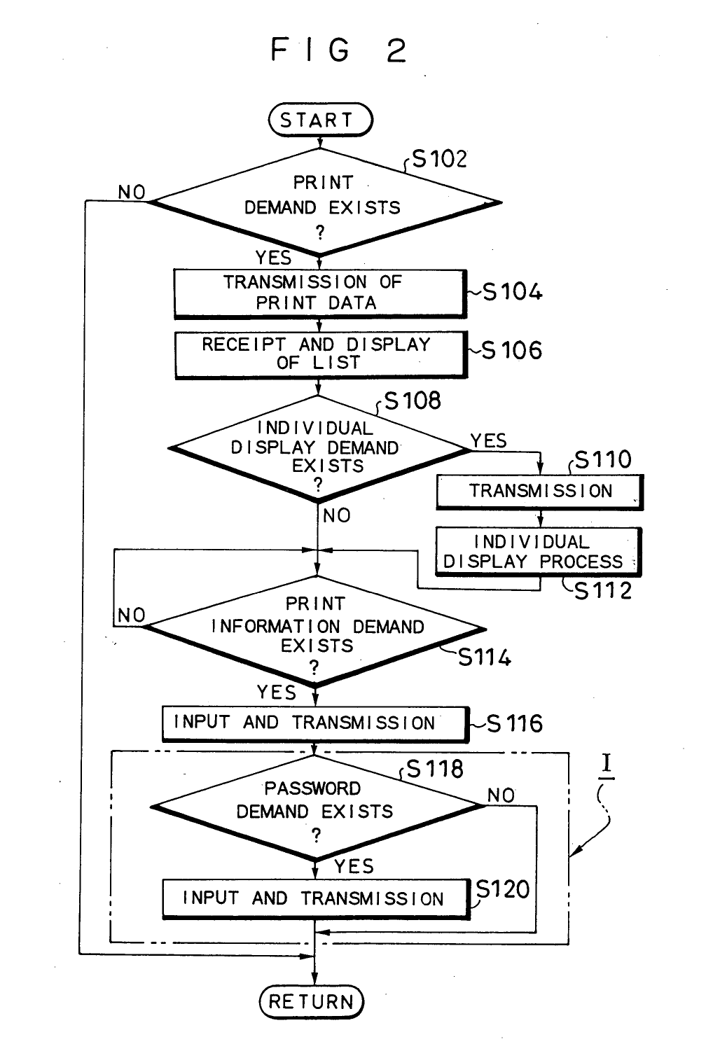

Next, referring to FIG. 2 to FIG. 5, explanation will be given on the procedures of input/output control processes executed in each of the personal computers 2 and the printer 1 when the operation from each of the plural personal computers 2 causes the printer 1 to output and print a document, drawing, or the like in the configuration described above.

Firstly, the process procedure in each of the personal computers 2 will be explained with reference to FIG. 2.

Note first that a series of processes shown in FIG. 2 is in the state in which it is executed as a subroutine in the personal computer 2. This means that the personal computer 2 has a main routine consisting of various kinds of subroutine processes depending on how it is used, and executes the main routine cyclically, and the subroutine shown in FIG. 2 is cyclically executed as one of such plural subroutine processes.

When this subroutine process is started, it is first judged whether or not there exists a print demand from a user (refer to Step S102 in FIG. 2). Specifically, the judgment on whether or not there exists the print demand from the user is made based on, for example, whether or not a predetermined command for the print demand is inputted, whether or not a predetermined key for the print demand is pressed, or the like.

Then, when it is judged that the print demand exists (YES), the procedure proceeds to Step S104, which will be described next. When, on the other hand, it is judged that no print demand exists(NO), this subroutine is tentatively finished and the procedure returns to the not-shown main routine.

In Step S104, print data of a document, drawing, or the like for which the print demand has been given by the user of the personal computer 2 is transmitted to the printer 1.

In response to the transmission of this print data, a list of documents, drawings, and so on to be printed, which are stored in the printer 1, is transmitted from the printer 1 as will be described later, and consequently, the personal computer 2 displays the list in a display section 2a thereof upon receiving the list (refer to Step S106 in FIG. 2).

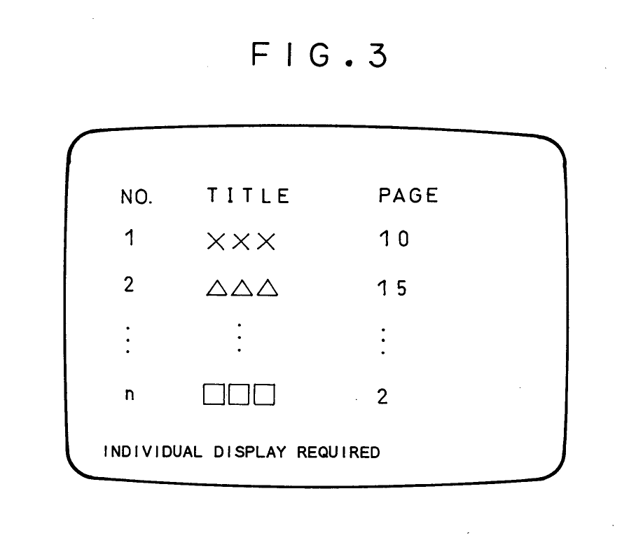

Concrete examples of suitable contents of the displayed list, an example of which is shown in FIG. 3, are items such as ‘the document number’ ascending from the Arabic numeral 1, which is assigned in the order of the storage in the printer 1, ‘the title’, and ‘the number of pages’ of documents, drawings, or the like.

Subsequently, it is judged whether or not there exists an individual display demand from the user (refer to Step S108 in FIG. 2). In this embodiment, the list of the documents or the like to be printed, which are stored in the printer 1, is displayed in the display section 15 of the printer 1 and the display section 2a of the personal computer 2, as shown in FIG. 3, and the display of the contents of an individual document, namely individual display is also possible when desired.

This individual display is suitably realized by, for example, a so-called user's double click of the document number assigned to a document, drawing, or the like of which the user wants the individual display, in the list (refer to FIG. 3) displayed in the display section 2a of the personal computer 2. Alternatively, the individual display demand may also be determined by double click of a phrase for demanding the individual display, for example, ‘individual display required’ or the like (refer to FIG. 3) which is displayed in an appropriate place of a window for the aforesaid list display shown in FIG. 3.

Then, when it is judged in Step S108 based on the user's operation as described above that the individual display demand exists (YES), the individual display demand is transmitted to the printer 1 (refer to Step S110 in FIG. 2). Subsequently, in response to the individual display demand, the individual display is executed in the printer 1 and the personal computer 2 in the manner, for example, described next (refer to Step S112 in FIG. 2).

The individual display demand is given in a list display mode, for example, as shown in FIG. 3 by double click of the document number of the document, drawing, or the like of which the individual display is desired or by double click of the phrase for the individual display demand (for example, the aforesaid ‘individual display required’) displayed in the display section 2a. In response to this individual display demand, a command to ask the designation is transmitted from the printer 1 to the personal computer 2, the designation including, for example, the page number to be displayed and a display form, namely, whether the whole page to be displayed should be displayed in a reduced state, whether the display should be in the edited state in which a part of the page is displayed, whether only a top portion of the page (for example the first line in the case of a document) should be displayed, or the like. Consequently, the display section 2a of the personal computer 2 shifts from the aforesaid list display mode shown in FIG. 3 to a display mode in which the contents of the individual display as stated above are asked.

Then, the user inputs the page number to be displayed, selects a display form, and so on so that the contents of the input and the selection are transmitted to the printer 1, and the contents corresponding to the user's demand are transmitted to the personal computer 2 from the printer 1, so that the desired individual display is executed in the display section 2a.

After the individual display is executed as described above, or when it is judged in the previous process in Step S108 that no individual display demand exists (NO), it is judged whether or not a print information demand has been given from the printer 1 to the personal computer 2 (refer to Step S114 in FIG. 2). Here, the ‘print information’ means information on the document number assigned to the document, drawing, or the like that the user wants to print, information on whether all the pages should be printed or a specific page should be printed, and so on. The ‘print information demand’ means that a demand for these items is given from the printer 1 to the personal computer 2.

Then, in the personal computer 2, the user inputs the necessary print information so that the contents thereof are transmitted to the printer 1 (refer to Step S116 in FIG. 2).

Subsequently, it is judged whether or not there exists a password demand from the printer 1 (refer to Step S118 in FIG. 2). To be more specific, in the embodiment of the present invention, passwords can be set in advance for documents, drawings, or the like to be printed by the printer 1 when the user so desires.

When the document, drawing, or the like for which the print demand is given to the printer 1 as in the above-described manner has this password setting, the printer 1 transmits to the personal computer 2 a password demand for demanding the input of the password. In Step S118, it is judged whether or not there exists this password demand.

Then, when it is judged that there exists no password demand (NO), a series of the processes is finished and the procedure tentatively returns to the not-shown main routine. When, on the other hand, it is judged in Step S118 that the password demand exists (YES), a password input demand to the user is appropriately displayed in the display section 2a, and the password, when inputted by the user, is transmitted to the printer 1 (refer to Step S120 in FIG. 2). Then, when a series of the processes is finished, the procedure tentatively returns to the not-shown main routine.

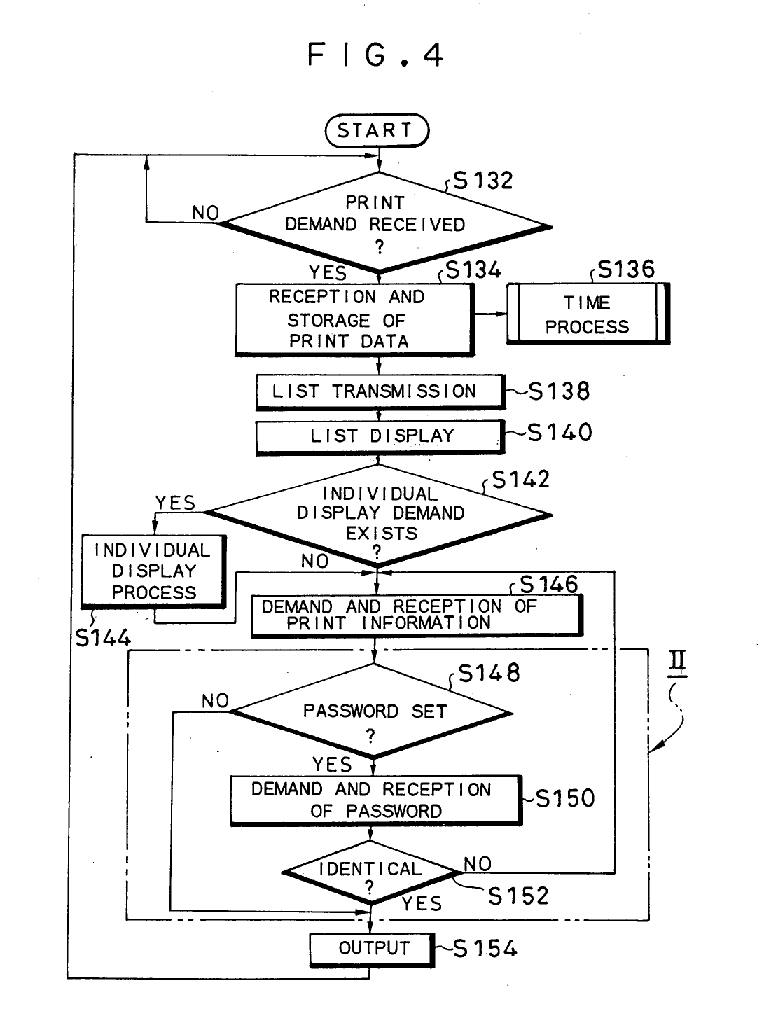

Secondly, a process procedure in the printer 1 will be explained with reference to FIG. 4.

When the process is started, first, judgment on whether or not the print demand is received from the personal computer 2 is repeated until the judgment that the print demand exists is made (refer to Step S132 in FIG. 4). Then, when it is judged that the print demand is received, the print data (refer to Step S104 in FIG. 2) transmitted from the personal computer 2 is received, and the received print data is stored in the storage unit 13 (refer to Step S134 in FIG. 4). In this process in Step S134, a time process subroutine is started at the same time (refer to Step S136 in FIG. 4).

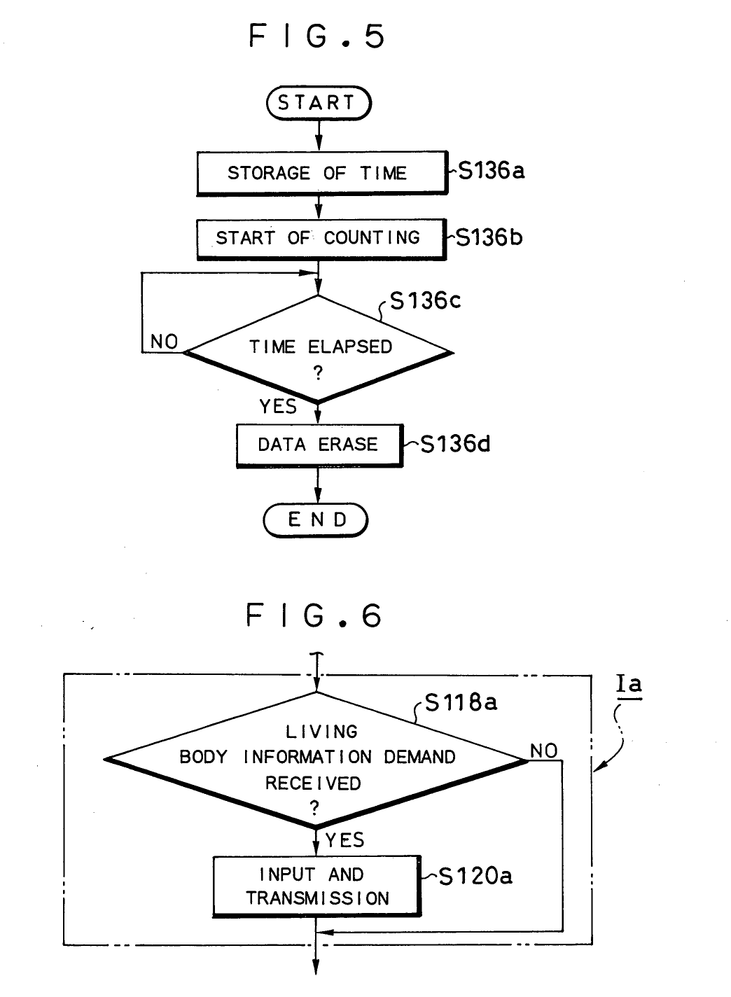

This time process subroutine is intended for keeping the print data stored in the storage unit 13 only during a predetermined period of time. FIG. 5 shows a concrete process procedure thereof, and here, a process procedure of this time process subroutine will be explained with reference to this drawing.

When the time process subroutine process is started, the time at which the print data is stored in the storage unit 13, which is executed in the previous Step S134, is first stored (refer to Step S136a in FIG. 5). Subsequently, counting of the elapsed time from the time at which the print data is stored in the storage unit 13 is started (refer to Step S136b in FIG. 5).

Subsequently, the judgment on whether or not the predetermined period time has passed from the time stored in the previous process in Step S136a is made until it is judged that the predetermined period of time has passed (refer to Step S136c in FIG. 5).

Then, when it is judged in Step S136c that the predetermined period of time has passed (YES), the print data in question stored in the storage unit 13 is erased (refer to Step S136d in FIG. 5), and a series of processes is finished.

Here, the explanation returns again to FIG. 4. After the aforesaid process in Step S134 is performed, the list of the documents, drawings, and so on to be printed which are stored in the printer 1 is transmitted to the personal computer 2 (refer to Step S138 in FIG. 4). Subsequently, the same contents of the list as those transmitted to the personal computer 2 are displayed in the display section 15 (refer to Step S140 in FIG. 4). A concrete example of the list displayed in the display section 15 is the same as that previously explained in the process procedure performed in the personal computer 2 (refer to FIG. 3), and therefore, repeated detailed explanation thereof will be omitted here.

Subsequently, it is judged whether or not there exists the individual display demand from the personal computer 2 (refer to Step S142 in FIG. 4). When it is judged that there exists no individual display demand (NO), the procedure proceeds to Step S146 while proceeding to Step S144 when it is judged that the individual display demand exists (YES).

Since an individual display process in Step S144 corresponds to the individual display process on the personal computer 2 side previously explained (refer to Step S112 in FIG. 2) and the basic contents thereof are the same as those described previously, the outline thereof will be explained here.

In Step S144, the command asking the designation of the display form as previously explained in Step S112 in FIG. 2 is first transmitted to the personal computer 2, and display data corresponding to the designated contents of the display form, which is transmitted from the personal computer 2 in response to the command transmission, is transmitted to the personal computer 2 and individually displayed in the display section 2a of the personal computer 2. The same display is also performed in the display section 15 of the printer 1.

Subsequently, in Step S146, the print information demand is given to the personal computer 2, and the print information transmitted from the personal computer 2 is received.

Subsequently, it is judged whether or not the document, drawing, or the like for which the print demand has been given from the personal computer 2 has the password setting (refer to Step S148 in FIG. 4), and when it is judged that it does not have any password setting (NO), the demanded document, drawing, or the like is outputted (printed) (refer to Step S154 in FIG. 4) based on the previously received print information (refer to Step S146 in FIG. 4), and the procedure returns to the previous process in Step S132 again. When, on the other hand, it is judged in Step S148 that the document, drawing, or the like has the password setting (YES), the password demand is given to the personal computer 2 and the password transmitted from the personal computer 2 (refer to Step S120 in FIG. 2) is received (refer to Step 150 in FIG. 4).

Subsequently, it is judged whether or not the received password is identical to the password set for the document, drawing, or the like for which the print demand has been given (refer to Step S152 in FIG. 4), and when it is judged that the passwords are identical to each other (YES), the demanded document, drawing, or the like is outputted (printed) (refer to Step S154 in FIG. 4) based on the previously received print information (refer to Step S146 in FIG. 4) as already explained. Then, the procedure returns to the previous process in Step S132 again. When, on the other hand, it is judged in Step S152 that the passwords are not identical to each other (NO), the procedure returns to the previous process in Step S146 again, and the above-described processes such as the print information demand to the personal computer 2 are repeated again.

In the above-described control example, confidentiality of the printed document, drawing, or the like can be ensured by the password. However, the method of ensuring confidentiality is not of course limited to the password, and so-called living body information such as a fingerprint or an IC card may also be used to enable an authentication process.

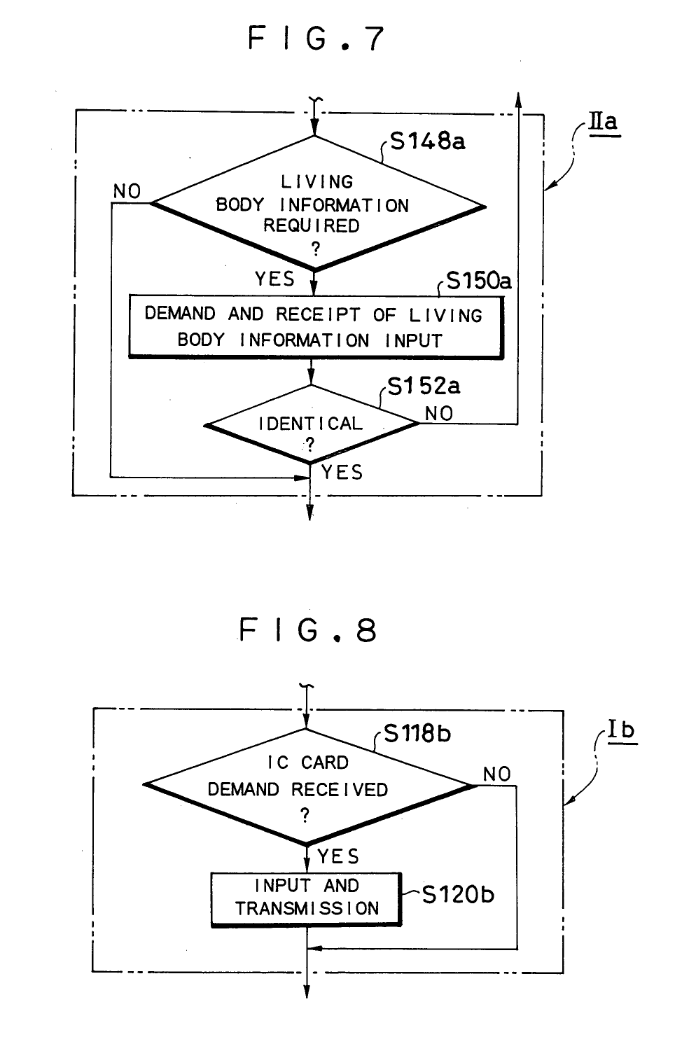

A control example when the living body information is used instead of the password will be explained below with reference to FIG. 1, FIG. 6, and FIG. 7.

To begin with, the system configuration will be explained with reference to FIG. 1. When the living body information is used instead of the password, the configuration that the living body information reading units 4 are connected to the personal computers 2 in the configuration shown in FIG. 1 can be adopted.

Here, each of the living body information reading units 4 has a structure well-know in the art for reading, for example, fingerprints, faces, irises, and the like.

In this case, the process procedure in the personal computer 2 and the process procedure in the printer 1 are basically the same as those shown in FIG. 2 and FIGS. 4 and 5 respectively except that only the processes in the portion surrounded by the two-dot chain line and denoted by the reference symbol I in FIG. 2 and the processes in the portion surrounded by the two-dot chain line and denoted by the reference symbol II in FIG. 4 are changed as will be described later in the personal computer 2 and in the printer 1 respectively.

Firstly, the process procedure in the personal computer 2 will be explained with reference to FIG. 6. The process procedure in the portion surrounded by the two-dot chain line and denoted by the reference symbol Ia in FIG. 6 corresponds to the aforesaid process procedure in the portion denoted by the reference symbol I in FIG. 2, and is the process procedure appropriate for the use of the living body information instead of the password.

The explanation below will be given with reference to FIG. 6 and FIG. 2. First, when the necessary print information, after inputted by the user, is transmitted to the printer 1 in Step S116 (refer to FIG. 2) as previously explained, it is subsequently judged in Step S118a (refer to FIG. 6) whether or not there exists a living body information demand from the printer 1. When it is judged that no living body information demand exists (NO), a series of the processes is finished and the procedure tentatively returns to the not-shown main routine. When, on the other hand, it is judged in Step S118a that the living body information demand from the printer 1 exists (YES),the personal computer 2 causes the living body information reading unit 4 to be prepared for receiving the input of the living body information. Accordingly, the user presses a predetermined finger onto the living body information reading unit 4, which in turn reads fingerprint data, or the user puts his/her face in front of a predetermined position of the living body information reading unit 4, which in turn reads the information on the living body such as his/her face or iris. Through this process, the living body information is inputted and transmitted to the printer 1 via the personal computer 2 (refer to Step S120a in FIG. 6).

Secondly, the process procedure in the printer 1 will be explained with reference to FIG. 7. The process procedure in the portion surrounded by the two-dot chain line and denoted by the reference symbol Ia in FIG. 7 corresponds to the aforesaid process procedure in the portion denoted by the reference symbol II in FIG. 4, and is the process procedure appropriate for the use of the living body information instead of the password.

The explanation below will be given with reference to FIG. 7 and FIG. 4. First, when the print information demand is given to the personal computer 2 and the print information transmitted from the personal computer 2 is received in Step S146 (refer to FIG. 4) as previously explained, it is subsequently judged in Step S148a (refer to FIG. 7) whether or not the document, drawing, or the like for which the print demand has been given from the personal computer 2 has the living body information setting instead of the password setting.

Then, when it is judged in Step. S148a that the document, drawing, or the like for which the print demand has been given does not have any living body information setting (NO), the procedure proceeds to an output process (refer to Step S154 in FIG. 4). When, on the other hand, it is judged. in Step S148a that the document, drawing, or the like for which the print demand has been given has the living body information setting (YES), the living body information demand is given to the personal computer 2 and the living body information transmitted from the personal computer 2 (refer to Step S120a in FIG. 6) is received (refer to Step S150a in FIG. 7).

Subsequently, it is judged whether or not the received living body information is identical to the living body information set for the document, drawing, or the like for which the print demand has been given (refer to Step S152a in FIG. 7), and when it is judged that the received living body information is identical (YES), the procedure proceeds to Step S154 shown in FIG. 4, where the printed document, drawing, or the like is outputted. When, on the other hand, it is judged in Step S152a that the living body information is not identical (NO), the procedure returns to the previous process in Step S146 shown in FIG. 4, and the aforesaid processes such as the print information demand to the personal computer 2 are repeated again.

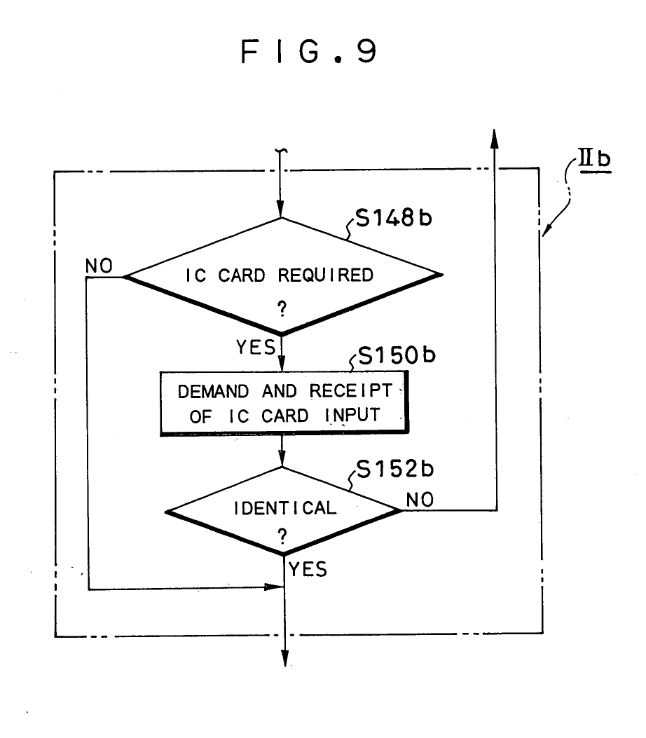

Next, the management of printed documents, drawings, or the like through the use of the IC card 6 instead of the password will be explained with reference to FIG. 1, FIG. 8, and FIG. 9.

To begin with, the system configuration will be explained with reference to FIG. 1. When the IC card 6 is used instead of the password, the configuration that the IC card reading units 5 are connected to the personal computers 2 in the configuration shown in FIG. 1 can be adopted.

Here, the IC card 6 and each of the IC card reading units 5 both have structures well-known in the art. It is assumed that the IC card 6 has, for example, an employee number stored thereon together with other information, and the employee number stored on the IC card 6 is used for the management of printed documents, drawings, or the like in a process procedure example explained below.

Firstly, a process procedure in the personal computer 2 will be explained with reference to FIG. 8. A process procedure in the portion surrounded by the two-dot chain line and denoted by the reference symbol Ib in FIG. 8 corresponds to the aforesaid process procedure in the portion denoted by the reference symbol I in FIG. 2, and is the process procedure appropriate for the use of the employee number stored on the IC card 6 instead of the use of the password.

The explanation below will be given with reference to FIG. 8 and FIG. 2. First, when the necessary print information is inputted by the user and the information is transmitted to the printer 1 in Step S116 (refer to FIG. 2) as previously explained, it is subsequently judged in Step S118b (refer to FIG. 8) whether or not there exists an input demand for data on the IC card 6 from the printer 1. When it is judged that no input demand for the data on the IC card 6 exists (NO), a series of the processes is finished and the procedure tentatively returns to the not-shown main routine.

When, on the other hand, it is judged in Step S118b that the input demand for the data on the IC card 6 from the printer 1 exists (YES), the personal computer 2 causes the IC card reading unit 5 to be prepared for receiving the input of the IC card 6. Accordingly, when the user inserts his/her own IC card 6 to the IC card reading unit 5, the data on the IC card 6 is read, is inputted to the personal computer 2 from the IC card reading unit 5, and transmitted to the printer 1 via the personal computer 2 (refer to Step S120b in FIG. 6).

Secondly, a process procedure in the printer 1 will be explained with reference to FIG. 9. A process procedure in the portion surrounded by the two-dot chain line and denoted by the reference symbol IIb in FIG. 9 corresponds to the aforesaid process procedure in the portion denoted by the reference symbol II in FIG. 4, and is the process procedure appropriate for the use of the IC card instead of the use of the password.

The explanation below will be given with reference to FIG. 9 and FIG. 4. First, when the print information demand is given to the personal computer 2 and the print information transmitted from the personal computer 2 is received in Step S146 (refer to FIG. 4) as previously explained, it is subsequently judged in Step S148b (refer to FIG. 9) whether or not the document, drawing, or the like for which the print demand has been given from the personal computer 2 has the setting as requiring data input by the IC card 6 instead of the password setting. Here, as concrete examples of data inputted from the IC card 6, for example, the employee number, the number assigned to the person in charge which is set in advance, and the like can be considered.

Then, when it is judged in Step S148b that the document, drawing, or the like for which the print demand has been given does not have any setting as requiring the data input by the IC card 6 (NO), the procedure proceeds to the process in Step S154 (refer to FIG. 4). When, on the other hand, it is judged in Step S148b that the document, drawing, or the like for which the print demand has been given has the setting as requiring the data input by the IC card 6 (YES), the data input demand by the IC card 6 is given to the personal computer 2 (refer to Step S150b in FIG. 9). Then, in response to this demand, the IC card reading unit 5 reads the data on the IC card 6 as previously stated, and the read data transmitted from the personal computer 2 (refer to Step S120b in FIG. 8) is received (refer to Step S150b in FIG. 9).

Subsequently, it is judged whether or not the received data read from the IC card 6, for example, the employee number is identical to the data on the IC card 6 set for the document, drawing, or the like for which the print demand has been given (refer to Step S152b in FIG. 9), and when it is judged that the data is identical (YES), the procedure proceeds to Step S154 shown in FIG. 4, where the printed document, drawing, or the like is outputted. When, on the other hand, it is judged in Step S152b that the data on the IC card 6 is not identical (NO), the procedure returns to the previous process in Step S146 shown in FIG. 4, and the processes previously described such as the print information demand to the personal computer 2 are repeated again.

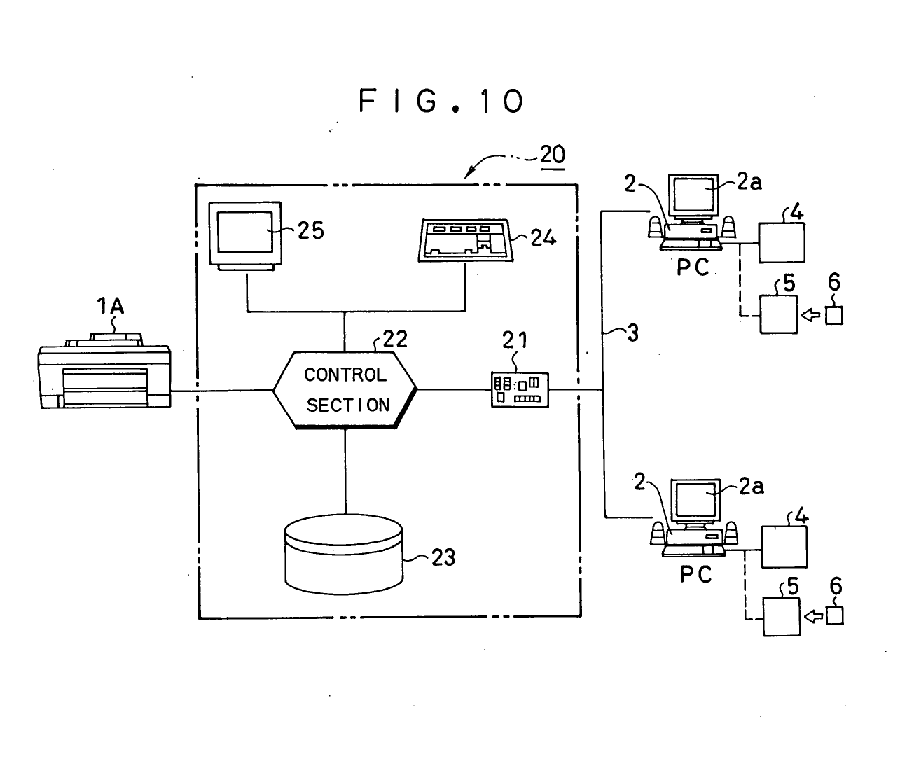

Next, a second configuration example of a system for controlling input/output of network office equipment in an embodiment of the present invention will be explained with reference to FIG. 10. Note that the same reference numerals and symbols are used to designate the same components as those shown in FIG. 1 to omit detailed explanation thereof, and only what is different is focused on in the explanation below.

Note first that a system S2 for controlling input/output of network office equipment in this second configuration example has the same configuration as the aforesaid configuration shown in FIG. 1 in that a plurality of personal computers 2 are LAN-connected. This configuration example is different from the aforesaid configuration example shown in FIG. 1 in that it is so configured that a printer 1A is LAN-connected to the plural personal computers 2 via a print server 20.

The print server 20 as the network office equipment in this configuration example is composed of a network interface 21, a control section 22, a storage unit 23, an operation section 24, and a display section 25 as its main constituent elements.

The network interface 21 has a structure well-known in the art for interfacing with the plural personal computers 2 which are LAN-connected, thereby enabling mutual data exchange between the print server 20 and the plural personal computers 2.

The control section 22 controls the operation of the whole printer server 20 so as to cause input/output control processes as will be described later to be executed. The control section 22 thus configured is realized by, for example, a microcomputer and software, and the one thus realized is suitable.

The storage unit 23 stores therein control programs executed in the control section 22 and various kinds of data, and concrete examples usable as the storage unit 23 are various kinds of storage mediums well-known in the art such as a so-called magnetic recording medium, magneto-optic storage medium, semiconductor storage medium, for example, a hard disk (HDD), a magneto-optic disk, and the like.

The operation section 24 includes various kinds of operation keys and a ten-key pad which are necessary when the selection of an object to be printed and so on are all performed in this print server 20 instead of being instructed from each of the personal computers 2 as will be described later.

The display section 25 has a structure well-known in the art for list display and the like of documents, drawings, or the like to be printed which are stored in this print server 20.

In such a configuration, the procedures of input/output control processes executed in the personal computers 2 and the print server 20 when the operation from each of the plural personal computers 2 causes the printer 1A via the print server 20 to output and print a document, drawing, or the like are basically the same as those previously explained with reference to FIG. 2 to FIG. 9.

This means that the process procedure here is basically the same as the aforesaid process procedure shown in FIG. 2 except that, in the plural personal computers 2, a party to which the print data is transmitted and from which the list is received, namely, a communication opponent is changed from the printer 1 in the configuration example shown in FIG. 1 to the print server 20. In this case, needless to say, the previously shown display example in FIG. 3 is also suitable as a display example of the display section 25.

Further, in this configuration example, it is basically possible to execute the aforesaid processes for the input/output control shown in FIG. 4 in the control section 22 of the print server 20. In this case, at the time of the output process in Step S154 in FIG. 4, the print data can be outputted from the print server 20 to the printer 1A so that the printer 1A executes printing.

Further, similarly to the configuration example described above, confidentiality of the printed document, drawing, or the like can be ensured through the use of the living body information or the IC card 6 instead of the use of the password by changing the process in the portion denoted by the reference symbol I in the process procedure shown in FIG. 2 to the process shown in FIG. 6 or FIG. 8 and by changing the process in the portion denoted by the reference symbol II in the process procedure shown in FIG. 4 to the process shown in FIG. 7 or FIG. 9, as explained above.

Repeated detailed explanation of each of FIG. 2 to FIG. 9 will be omitted here.

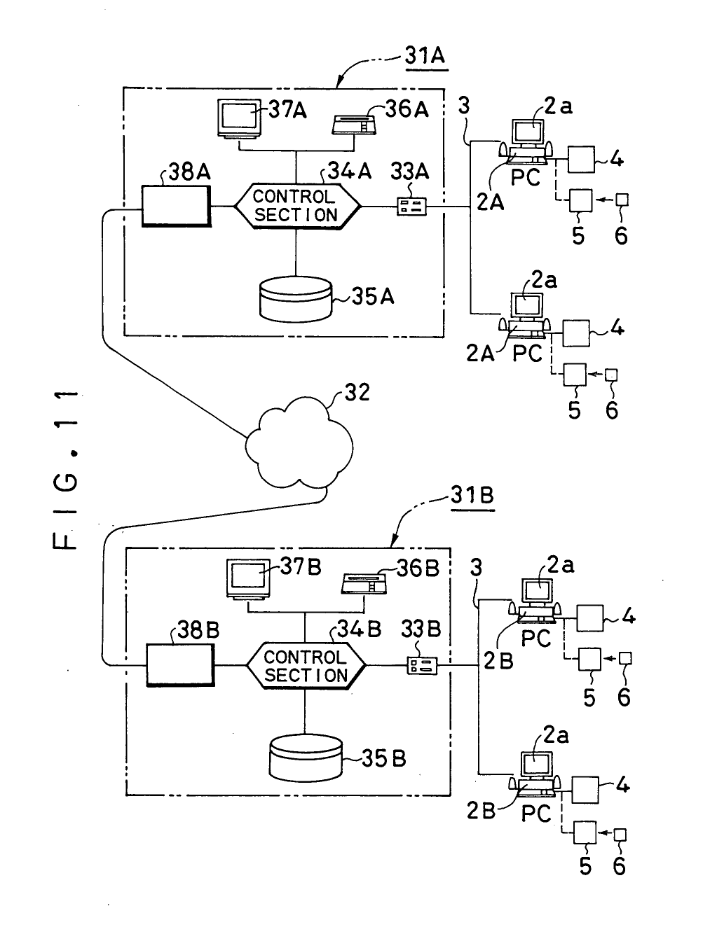

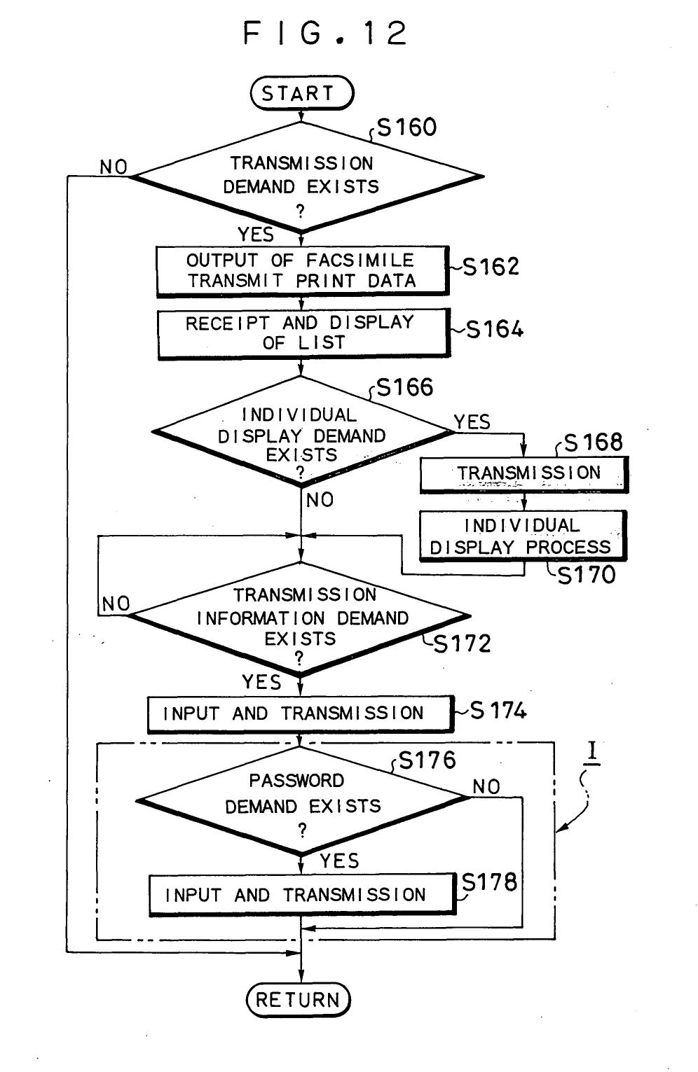

Next, a third configuration example will be explained with reference to FIG. 11 to FIG. 15. Note that the same reference numerals and symbols are used to designate the same components as those shown in FIG. 1 to omit detailed explanation thereof, and only what is different is focused on in the explanation below.

This third configuration example is an application example when the network office equipment is a facsimile machine.

Note first that a system S3 for controlling input/output of network office equipment in this third configuration example is so configured that facsimile machines 31A, 31B are connected to each other via an external network 32 such as a public telephone circuit and the Internet, and the facsimile machines 31A, 31B are LAN-connected to a plurality of personal computers 2A, 2B respectively. Note that the facsimile machine 31A is defined as a transmitting side and the other facsimile machine 31B is defined as a receiving side in the following description for convenience of explanation. Further, the personal computers 2A are defined as being connected to the transmitting-side facsimile machine 31A and the personal computers 2B are defined as being connected to the receiving-side facsimile machine 31B.

This means that, in this configuration example, the transmitting-side facsimile 31A is LAN-connected to the plural personal computers 2A and the receiving-side facsimile machine 31B is LAN-connected to the plural personal computers 2B respectively.

The transmitting-side facsimile machine 31A and the receiving-side facsimile machine 31B have basically the same structure, and in the following explanation on the structure thereof, the same constituent elements will be explained with the reference symbols for both of them being written together.

The facsimile machine 31A, 31B in this configuration example is composed of a network interface 33A, 33B, a control section 34A, 34B, a storage unit 35A, 35B, an operation section 36A, 36B, a display section 37A, 37B, and a transmitting/receiving section 38A, 38B as its main constituent elements.

The network interface 33A, 33B has a structure well-known in the art for interfacing with the plural personal computers 2A, 2B which are LAN-connected, thereby enabling mutual data exchange between the facsimile machine 31A and the plural personal computers 2A and mutual data exchange between the facsimile machine 31B and the plural personal computers 2B.

The control section 34A, 34B controls the operation of the whole facsimile machine 31A, 31B to cause input/output control processes as will be described later to be executed. The control section 34A, 34B thus configured is realized by, for example, a microcomputer and software, and the one thus realized is suitable.

The storage unit 35A, 35B stores therein control programs executed in the control section 34A, 34B and various kinds of data, and concrete examples usable as the storage unit 35A, 35B are various kinds of storage mediums well-known in the art such as a so-called magnetic recording medium, magneto-optic storage medium, semiconductor storage medium, for example, a hard disk (HDD), a magneto-optic disk, and the like.

The operation section 36A, 36B includes various kinds of operation keys and a ten-key pad which are necessary when the selection and the like of a document, drawing, or the like to be facsimile-transmitted or -received are all performed in this facsimile machine 31A, 31B instead of being instructed from the personal computer 2A, 2B, as will be described later.

The display section 37A, 37B has a structure well-known in the art for list display and so on of documents, drawings, or the like to be transmitted or received which are stored in the facsimile machine 31A, 31B.

The transmitting/receiving section 38A, 38B is so configured to facsimile-transmit a document, drawing, or the like specified by a user in a later-described manner out of the documents, drawings, or the like to be facsimile-transmitted, which are stored in the storage units 35A, 35B, while receiving a facsimile signal from an external part, tentatively storing the facsimile signal in the storage unit 35A, 35B, and printing/outputting received data thus stored according to the control by the control section 34A, 34B as will be described later.

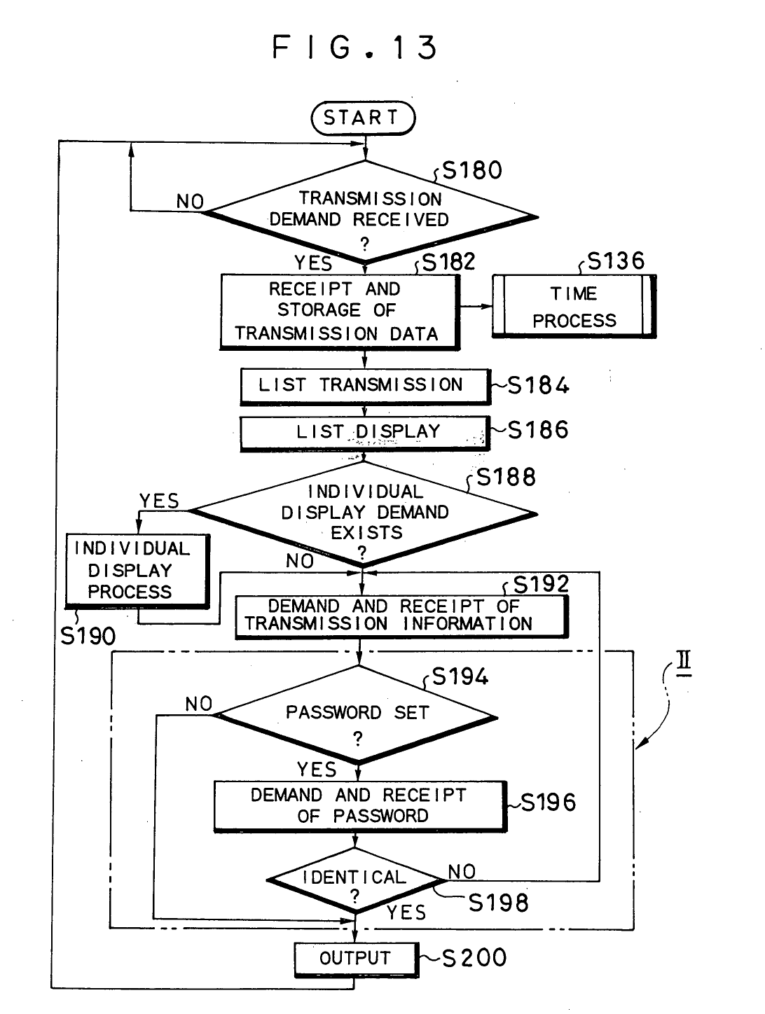

Next, referring to FIG. 12 and FIG. 13, explanation will be given on the procedures of input/output control processes executed in each of the personal computers 2A and the transmitting-side facsimile machine 31A when a document, drawing, or the like made out, edited, or the like in the personal computer 2A is transmitted from the transmitting-side facsimile machine 31A to the receiving-side facsimile machine 31B in the configuration described above.

Note first that a series of processes shown in FIG. 12 is in the state in which it is executed as a subroutine, similarly to the aforesaid process procedure shown in FIG. 2. The process procedure shown in FIG. 12 is basically the same as the aforesaid process procedure shown in FIG. 2, but since a part of the processes should be described in different expressions from the expressions used in FIG. 2 due to the fact that a communication opponent of the personal computer 2A is the transmitting-side facsimile machine 31A, the following explanation will focus on what is different and detailed explanation of especially the steps including basically the same process contents as those in FIG. 2 will be omitted.

First, when the process is started, it is judged whether or not a facsimile transmission demand for a document, drawing, or the like from a user exists (refer to Step S160 in FIG. 12). To be more specific, the judgment on the existence or nonexistence of the facsimile transmission demand from the user is made based on, for example, whether or not a predetermined command for the facsimile transmission demand has been inputted, whether or not a predetermined key for the facsimile transmission demand has been pressed, or the like.

Then, when it is judged that the facsimile transmission demand exists (YES), the procedure proceeds to Step S162, which will be described next. When, on the other hand, it is judged that no facsimile transmission demand exists (NO), this subroutine process is tentatively finished and the procedure returns to a not-shown main routine.

In Step S162, facsimile transmission data of a document, drawing, or the like that the user wants to facsimile-transmit is transmitted from the personal computer 2A to the transmitting-side facsimile machine 31A.

Then, processes in and after Step S164 are executed similarly to the aforesaid processes in and after Step S106 in FIG. 2. Note that the ‘transmission information’ in the process in Step S172 is information such as the document number assigned to the document, drawing, or the like that the user wants to facsimile-transmit and the designation of the transmission of all the pages or a specific page. The ‘transmission information demand’ means that a demand for these items is given from the transmitting-side facsimile machine 31A to the personal computer 2A.

Next, the process procedure in the transmitting-side facsimile machine 31A will be explained with reference to FIG. 13. The process procedure shown in FIG. 13 is also basically the same as the aforesaid process procedure shown in FIG. 4, but since a part of the processes should be described in different expressions from the expressions used in FIG. 4 due to the fact that the processes here are the processes in the transmitting-side facsimile machine 31A, the following explanation will focus on what is different and detailed explanation of especially the steps including basically the same process contents as those in FIG. 4 will be omitted.

When the process is started, judgment on whether or not the facsimile transmission demand as stated above is received from the personal computer 2A is repeated until it is judged that the transmission demand exists (refer to Step S180 in FIG. 13). Then, when it is judged that the transmission demand is received, the data of the document, drawing, or the like to be facsimile-transmitted which has been transmitted from the personal computer 2A is received, and the received data is stored in the storage unit 35A (refer to Step S182 in FIG. 13). Further, at this time, the time process subroutine already explained is started and executed (refer to Step S136 in FIG. 13) as in the aforesaid process procedure shown in FIG. 4.

Then, processes in and after Step S184 are executed similarly to the aforesaid processes in and after Step S138 shown in FIG. 4. Note that ‘transmission information’ in the process in Step S192 is the same as that previously explained in Step S170, and the ‘transmission information demand’ is a demand for the transmission information given to the personal computer 2A from the transmitting-side facsimile machine 31A. The ‘output’ in Step S200 means that facsimile transmission is performed by the transmitting-side facsimile machine 31A.

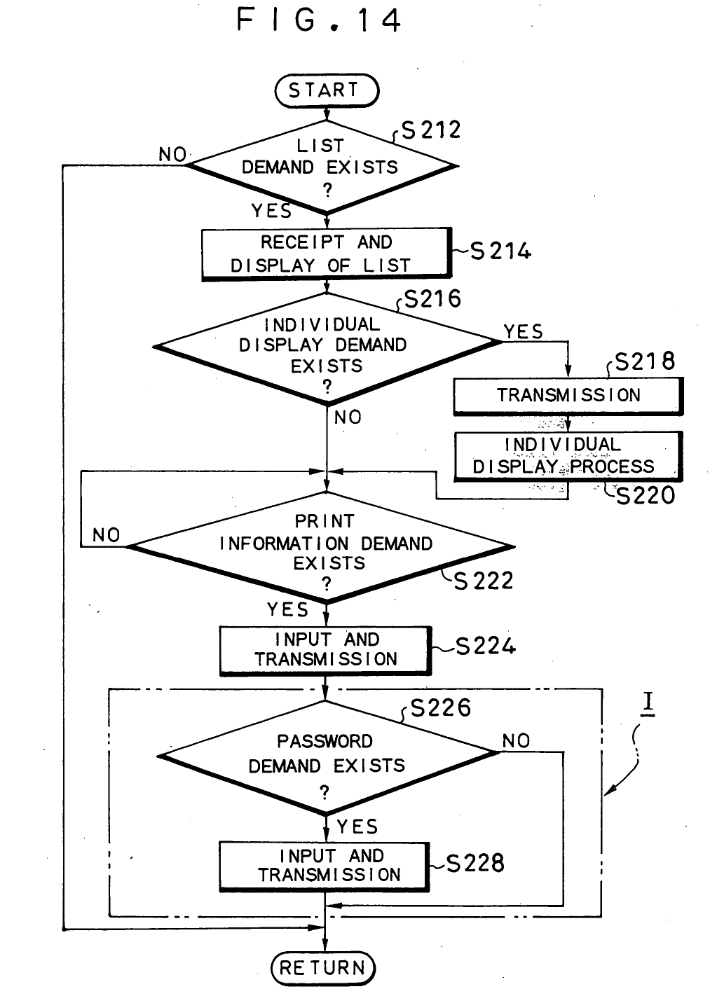

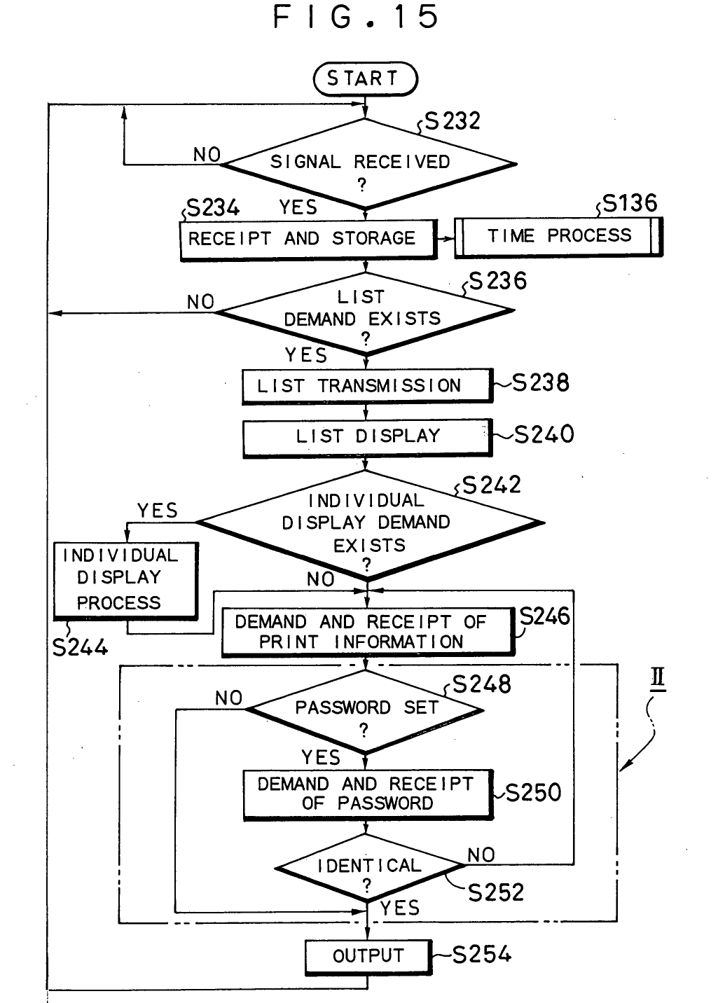

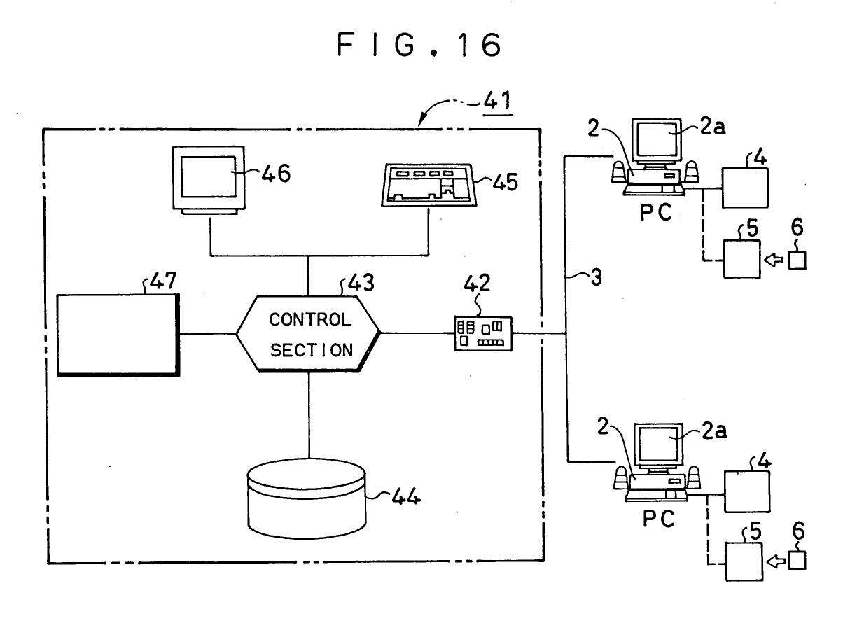

Next, referring to FIG. 14 and FIG. 15, explanation will be given on the procedure of input/output control processes executed in each of the plural personal computers 2B and the receiving-side facsimile machine 31B when the operation in each of the plural personal computers 2B causes the facsimile machine 31B to output the document, drawing, or the like received by the receiving-side facsimile machine 31B in the configuration described above.

Firstly, a process procedure in the personal computer 2B will be explained with reference to FIG. 14.

Note first that a series of processes shown in FIG. 14 is in the state in which it is executed as a subroutine as in the aforesaid process procedure shown in FIG. 2.

When the process is started, it is first judged whether or not the user has given a list demand (refer to Step S212 in FIG. 14). To be more specific, it is judged whether or not the user has operated the personal computer 2B to give to the receiving-side facsimile machine 31B a list demand for received facsimile documents, drawings, or the like already stored in the storage unit 35B. Here, the ‘list’ is the same list as that explained in the aforesaid configuration example shown in FIG. 1 with reference to FIG. 3.

When it is judged in Step S212 that no list demand has been given from the user (NO), a series of the processes is finished and the procedure tentatively returns to a not-shown main routine. When, on the other hand, it is judged in Step S212 that the list demand exists (YES), the list which is transmitted from the receiving-side facsimile machine 31B in response to the transmission of the list demand from the personal computer 2B to the receiving-side facsimile machine 31B is received to be displayed on a display section 2a of the personal computer 2B in the form, for example, shown in FIG. 3 (refer to Step S214 in FIG. 14).

Next, processes in and after Step S216 are executed, but since the processes in and after Step S216 are basically the same as the aforesaid processes in and after Step S108 shown in FIG. 2, detailed explanation on the individual processes in and after Step S216 will be omitted here. Note that a communication opponent of the personal computer 2B in the above processes in and after Step S216 is naturally the receiving-side facsimile machine 31B instead of the printer 1 in the processes in and after Step S108.

Secondly, the process procedure in the receiving-side facsimile machine 31B will be explained with reference to FIG. 15.

When the process is started, judgment on whether or not a transmission signal from the transmitting-side facsimile machine 31A is received is first repeated until it is judged that the transmission signal is received (refer to Step S232 in FIG. 15). Then, when it is judged that the transmission signal from the transmitting-side facsimile machine 31A is received, a facsimile signal of the document, drawing, or the like transmitted from the transmitting-side facsimile machine 31A is received, and the received contents are tentatively stored in the storage unit 35B (refer to Step S234 in FIG. 15). The time process subroutine is started at the same time in this process in Step S234 (refer to Step S136 in FIG. 15). Since this time process subroutine is the same as that explained previously with reference to FIG. 5, repeated detailed explanation thereof will be omitted here.

Then, it is judged whether or not the list demand from the personal computer 2B exists (refer to Step S236 in FIG. 15), and when it is judged that there exists no list demand (NO), the procedure returns to the previous process in Step S232 and the process is started from the beginning. When, on the other hand, it is judged in Step S236 that the list demand exists, the list is transmitted to the personal computer 2B (refer to Step S238 in FIG. 15). Here, the processes in and after Step S238 where the list is transmitted are basically the same as the aforesaid processes in and after Step S138 shown in FIG. 4. Therefore, detailed explanation on the individual processes in and after Step S238 will be omitted here.

Incidentally, also in the configuration example shown in FIG. 11, similarly to the configuration examples described above, confidentiality of the printed document, drawing, or the like can be ensured through the use of the living body information or the IC card 6 instead of the use of the password by changing the processes in the portion denoted by the reference symbol I in the process procedures shown in FIG. 12 and FIG. 14 to the process shown in FIG. 6 or FIG. 8 and by changing the processes in the portion denoted by the reference symbol II in the process procedures shown in FIG. 13 and FIG. 15 to the process shown in FIG. 7 or FIG. 9, as explained above.

Next, a fourth configuration example will be explained with reference to FIG. 16 to FIG. 18. Note that the same reference numerals and symbols are used to designate the same components as those shown in FIG. 1 to omit detailed explanation thereof, and only what is different is focused on in the explanation below.

Note first that a system S4 for controlling input/output of network office equipment in this fourth configuration example is so configured that a plurality of personal computers 2 and an image scanner 41 are LAN-connected.

The image scanner 41 as the network office equipment in this configuration example is composed of a network interface 42, a control section 43, a storage unit 44, an operation section 45, a display section 46, and a scanner section 47 as its main constituent elements.

The network interface 42 has a structure well-known in the art for interfacing with the plural personal computers 2 which are LAN-connected, thereby enabling mutual data exchange between the image scanner 41 and the plural personal computers 2.

The control section 43 controls the operation of the whole image scanner 41 so as to cause input/output control processes as will be described later to be executed. The control section 43 thus configured is realized by, for example, a microcomputer and software, and the one thus realized is suitable.

The storage unit 44 stores therein control programs executed in the control section 43 and various kinds of data, and concrete examples usable as the storage unit 44 are various kinds of storage mediums well-known in the art such as a so-called magnetic recording medium, magneto-optic storage medium, semiconductor storage medium, for example, a hard disk (HDD), a magneto-optic disk, and the like.

The operation section 45 includes various kinds of operation keys and a ten-key pad which are necessary when data load to the personal computer 2 is all performed in this image scanner 41 instead of being instructed from the personal computer 2 side as will be described later.

The display section 46 has a structure well-known in the art for list display and so on of documents, drawings, or the like which are stored in the image scanner 41.

The scanner section 47 has a structure well-known in the art for reading images of documents, drawings, or the like.

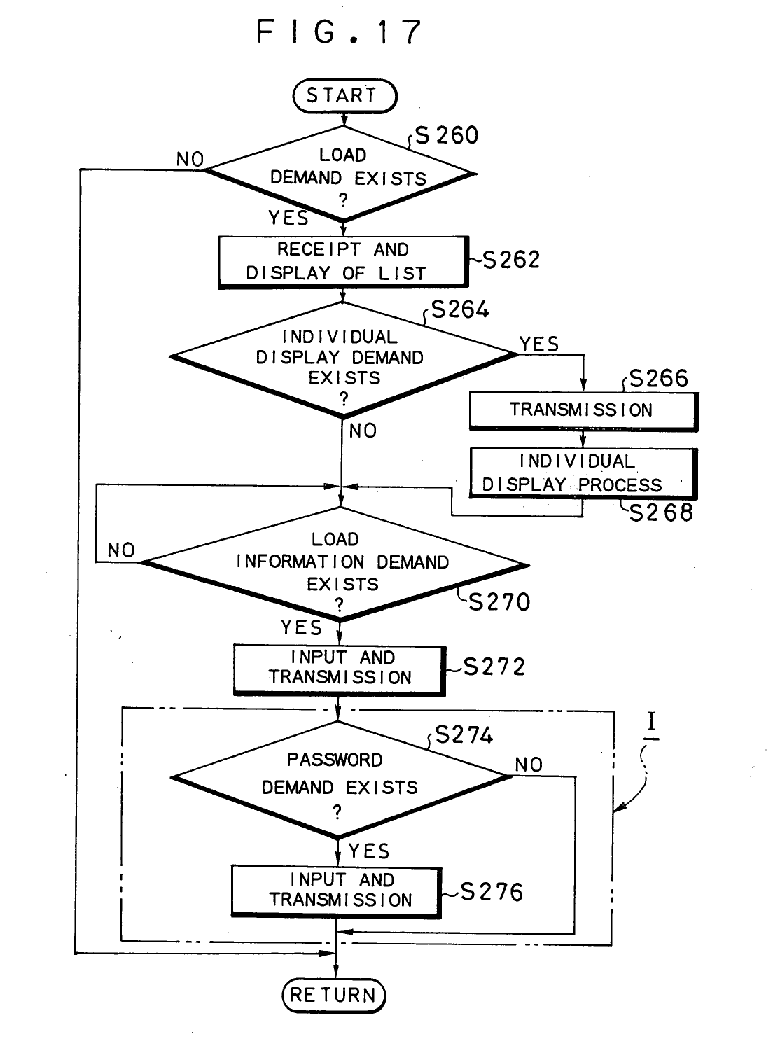

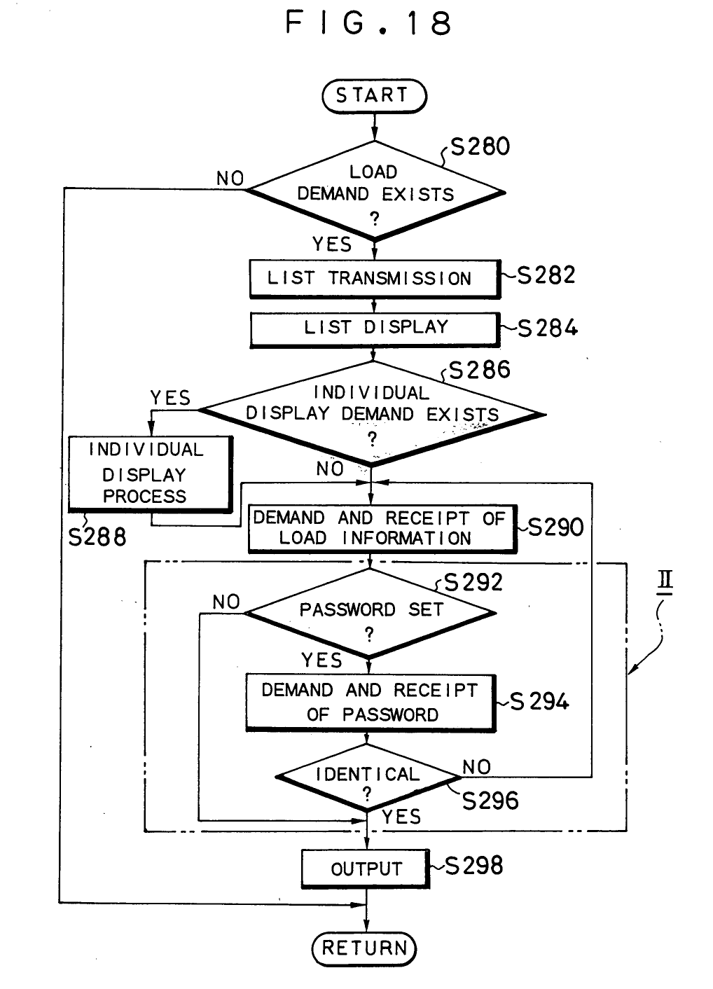

Next, referring to FIG. 17 and FIG. 18, explanation will be given on the procedures of input/output control processes executed in the personal computers 2 and the image scanner 41 when image data of a document, drawing, or the like read by the image scanner 41 is loaded in either one of the plural personal computers 2 in the configuration described above.

First, it is assumed that image data to be loaded to the personal computer 2 has been already read in the image scanner 41 and stored in the storage unit 44. Processes of reading an image of the document, drawing, or the like by the image scanner 41 may basically be processes well-known in the art and do not need to be special processes, but it is preferable that the time process subroutine as previously explained using FIG. 5 is started and executed at the same time when the image data is stored in the storage unit 44. As for the read image data requiring the password setting, it is assumed that the setting has been already made. Incidentally, the password setting for the image data may be a process well-known in the art.

Firstly, a process procedure executed in the personal computer 2 under such assumption will be explained with reference to FIG. 17. Note first that a series of processes shown in FIG. 17 is in the state in which it is executed as a subroutine similarly to the aforesaid process procedure shown in FIG. 2.

The process procedure shown in FIG. 17 is basically the same as the aforesaid process procedure shown in FIG. 2, but since a part of the processes should be described in different expressions from the expressions used in FIG. 2 due to the fact that a communication opponent of the personal computer 2 is the image scanner 41, the following explanation will focus on what is different and detailed explanation on especially the steps having basically the same process contents as the process contents in FIG. 2 will be omitted.

When the process is started, it is judged whether or not an image data load demand from a user to the image scanner 41 exists (refer to Step S260 in FIG. 17). To be more specific, the judgment on the existence or nonexistence of the image data load demand from the user is made based on, for example, whether or not a predetermined command for demanding that the image data stored in the image scanner 41 should be loaded to the personal computer 2 by the image scanner 41 has been inputted to the personal computer 2, whether or not a predetermined key for demanding that the image data be loaded by the image scanner 41, or the like.

Then, when it is judged that the image data load demand exists (YES), the procedure proceeds to Step S262, which will be described next. When, on the other hand, it is judged that no image data load demand exists (NO), this subroutine process is tentatively finished and the procedure returns to a not-shown main routine.

In Step S262, in response to the aforesaid image data load demand, a list sent from the image scanner 41 is received and displayed on a display section 2a of the personal computer 2. Here, the ‘list’ is a list of a set of the image data stored in the storage unit 44 of the image scanner 41, and a concrete example thereof is the same as that previously explained with reference to FIG. 3.

Then, processes in and after Step S264 are executed similarly to the aforesaid processes in and after Step S106 in FIG. 2. Note that the load information’ in the process in Step S270 is information such as a document number of the image data that the user wants to load to the personal computer 2 and the designation of the loading of all the pages or a specific page. The ‘load demand’ means that a demand for these items is given from the image scanner 41 to the personal computer 2.

Secondly, the process procedure executed in the image scanner 41 will be explained with reference to FIG. 18. The process procedure shown in FIG. 18 is in the state in which it is executed as a subroutine. The contents of each process are basically the same as the aforesaid process contents shown in FIG. 4, but since a part of the processes should be described in different expressions from the expressions used in FIG. 4 due to the fact that these processes are performed in the image scanner 41, the following explanation will focus on what is different and detailed explanation on especially the steps having basically the same process contents as the process contents in FIG. 4 will be omitted.

When the process is started, it is judged whether or not the image data load demand from the personal computer 2 exists (refer to Step S280 in FIG. 18), and when it is judged that no load demand exists (NO), a series of the processes is finished and the procedure tentatively returns to a not-shown main routine. When, on the other hand, it is judged in Step S280 that the image data load demand exists (YES), the list is transmitted to the personal computer 2 (refer to Step S282 in FIG. 18). To be more specific, the list of a set of the image data stored in the storage unit 44 of the image scanner 41, in other words, the list of a set of the image data in the form previously explained with reference to FIG. 3 is transmitted to the personal computer 2.

Then, processes in and after Step S284 are executed similarly to the aforesaid processes in and after Step S140 shown in FIG. 4. Note that the ‘load information’ in Step S290 is information such as the document number of the image data which the user wants to load to the personal computer 2 and the designation regarding whether all the pages or a specific page should be loaded, as stated in the previous explanation in Step S270. The ‘load information demand’ means that a demand for the load information is given to the personal computer 2 from the image scanner 41, and in Step S290, the load information demand is given and the load information transmitted from the personal computer 2 is received. The “output” in Step S298 means that the image scanner 41 transmits to the personal computer 2 the image data selected in the above-described manner.

Note that, also in the configuration example shown in FIG. 16 similarly to the configuration examples described above, confidentiality of the printed document, drawing, or the like can be ensured through the use of the living body information or the IC card 6 instead of the use of the password by changing the process in the portion denoted by the reference symbol I in the process procedure shown in FIG. 17 to the process shown in FIG. 6 or FIG. 8 and by changing the process in the portion denoted by the reference symbol II in the process procedure shown in FIG. 18 to the process shown in FIG. 7 or FIG. 9, as explained above.

All of the configuration examples described above can be called a so-called automated system in which the operation from the personal computer 2 side causes a desired document, drawing, or the like to be printed, facsimile-transmitted, and so on, and the following explanation will be on a configuration example which can be called a so-called semi-automated system in which a desired document, drawing, or the like is obtainable when a user who wants printing and so on thereof performs a predetermined operation in the printer 1 and so on.

First, taking the case of the printer as an example for explanation, a so-called hardware configuration in this case can be basically the same as the aforesaid configuration shown in FIG. 1.

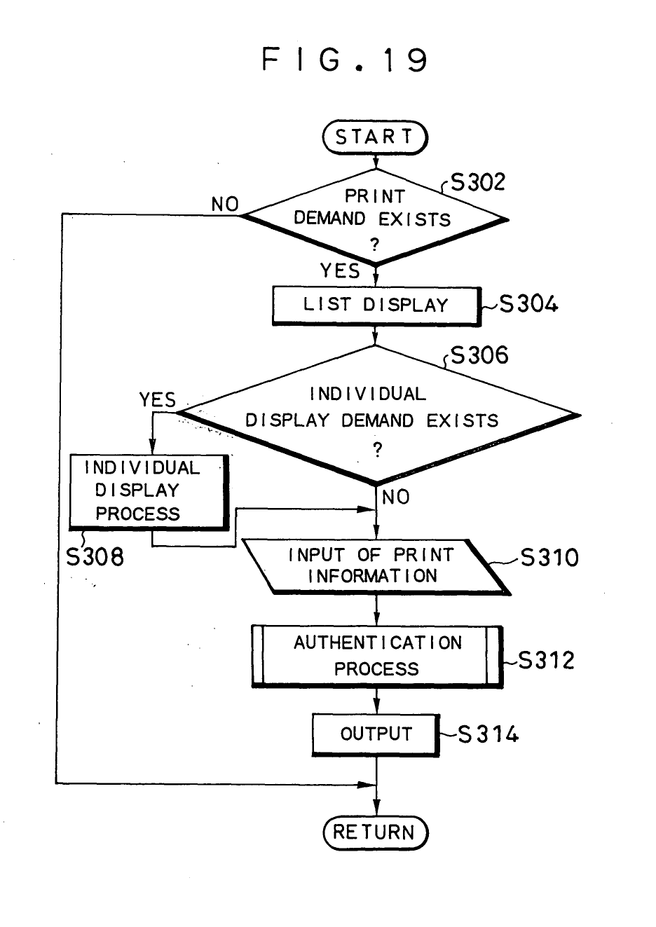

It is suitable that the input/output control executed by the control section 12 follows the process procedure shown in FIG. 19.

This procedure of input/output control processes will be explained below with reference to FIG. 19. Note that it is assumed that a document, drawing, or the like to be printed has already been transmitted from the personal computer 2 to the printer 1 and stored in the storage unit 13 when this input/output control is performed. Such a transmission process of the document, drawing, or the like from the personal computer 2 to the printer 1 may be a process well-known in the art and does not need to be a special process, but it is preferable that the time process subroutine as previously explained using FIG. 5 is started and executed at the same time when it is stored in the storage unit 13. It is assumed that the password setting, if required, was made for the document, drawing, or the like transmitted from the personal computer 2 to the printer 1 in advance at the time when the document, drawing, or the like was transmitted from the personal computer 2. A process well-known in the art is sufficient as such a process.

When the process in the printer 1 is started under such assumption, it is first judged whether or not a print demand has been given by the user in the operation section 11 (refer to Step S302 in FIG. 19). To be more specific, in this configuration example, the user who wants printing presses a predetermined key, inputs a predetermined command, or the like in the operation section 11 to give the print demand to the printer 1.

Subsequently, a list of documents, drawings, or the like stored in the storage unit 13 is displayed, for example, in the aforesaid form shown in FIG. 3 (refer to Step S304 in FIG. 19). Then, it is judged whether or not the user has given an individual display demand (refer to Step S306 in FIG. 19). Here, the user gives the individual display demand by pressing a predetermined key of the operation section 11, by inputting a predetermined command, or the like. Since the ‘individual display’ has the same meaning as that previously stated in Step S108 in FIG. 2 and in Step S142 in FIG. 4, repeated explanation thereof will be omitted here.

Then, processes in and after Step S308 are executed. Since the processes in and after Step S308 are basically the same as the aforesaid processes in and after Step S144 in FIG. 4, detailed explanation thereof will be omitted here. Note that the authentication process in Step S312 collectively represents the processes in Step S148 to Step S152 in FIG. 4 for convenience’ sake. Here, needless to say, the living body information or the IC card 6 may be used, in which case the authentication process in Step S312 is replaced by the process shown in FIG. 7 or FIG. 9 as previously explained.

Further, in such a configuration that the input/output control is performed as shown in FIG. 19 through the operation of the operation section 11 of the printer 1, it is also suitable that a selected document, drawing, or the like can be deleted, for example, in the list display (refer to Step S304 in FIG. 19) and in the individual display (refer to Step S308 in FIG. 19). To be more specific, such a configuration is suitable in the list display that, for example, a predetermined delete command is inputted from the operation section 11 or a predetermined key for deletion of the operation section 11 is pressed so that a window for demanding the document number assigned to a document, drawing, or the like to be deleted is displayed on the display section 15, and the document number assigned to the document, drawing, or the like to be deleted is subsequently inputted from the operation section 11 so that the corresponding document, drawing, or the like is deleted from the storage unit 13.

The input/output control shown in FIG. 19 may be applied to the print server 20 in the aforesaid configuration example shown in FIG. 10. In this case, the processes shown in FIG. 19 can be executed in the control section 22 of the print server 20.

It is also possible that, in the configuration example shown in FIG. 11, the input/output control shown in FIG. 19 is executed in the receiving-side facsimile machine 31B when the received document, drawing, or the like is outputted.

The examples having a wired LAN configuration are shown in the above-described configuration examples, but the present invention is of course applicable also to a wireless LAN configuration.

As described hitherto, according to the present invention, when the network office equipment is controlled to execute output, the necessary authentication process for the object requiring authentication of the password or the like is performed in the network office equipment, and the output is allowed only when the authentication process is normally made, which brings about such effects that confidentiality of documents, drawings, or the like is ensured in a network without fail and inadvertent output is prevented, resulting in the contribution to curtailment of expenses and so on owing to the prevention of useless output.

Further, the list of the documents, drawings, or the like to be outputted is displayed, which brings about an effect of improving convenience in specifying the output object.

Moreover, when the contents of each document, drawing, or the like are individually displayed after the list display mode, the contents can be easily confirmed before the document, drawing, or the like is outputted, which brings about such an effect that unnecessary or inadvertent output can be avoided, resulting in the contribution to curtailment of expenses and so on owing to the prevention of useless output.

What is claimed is:

1. An input/output control method in a system for controlling input/output of network office equipment comprising a plurality of computers and a network office equipment to constitute a network, the method comprising:
displaying a list of output objects stored in the network office equipment to allow selection of an output object from the list when an output demand is given to the network office equipment.

2. An input/output control method in a system for controlling input/output of network office equipment according to claim 1, the method further comprising:
when the output object is selected from the list, judging whether or not the selected output object requires an authentication process;
performing the authentication process when it is judged that the selected output object requires the authentication process; and
outputting only the selected output object for which the authentication process is normally finished.

3. An input/output control method in a system for controlling input/output of network office equipment according to claim 2, wherein individual display of an output object specified in the list is enabled in response to a demand.

4. An input/output control method in a system for controlling input/output of network office equipment according to claim 3, wherein a delete demand of an output object specified in the list is allowed, and when the delete demand is given, data of the output object stored in the network office equipment is deleted.

5. A computer program product for controlling input/output of network office equipment executed in a network office equipment in a system for controlling input/output of network office equipment, the system comprising a plurality of computers and a network office equipment to form a network, and the computer program product comprising:
program code means for executing an output demand acceptance step of accepting an output demand to the network office equipment;
program code means for executing a list display step of displaying a list of output objects stored in the network office equipment when the output demand is accepted;
program code means for executing an output object specifying step of specifying an output object for which the output demand is given; and
program code means for executing an output step of outputting the output object specified in said output object specifying step.

6. A computer program product for controlling input/output of network office equipment according to claim 5, further comprising:
program code means for executing an authentication judging step of judging whether or not the specified output object requires an authentication process when the output object is specified in said output object specifying step;
program code means for executing an authenticating step of performing the authentication process when it is judged in said authentication judging step that the specified output object requires the authentication process; and
program code means for executing an output control step of defining only the output object for which the authentication process is normally finished as the object in the output step.

7. A computer program product for controlling input/output of network office equipment according to claim 6, further comprising:
program code means for executing an individual display demand judging step of judging whether or not an individual display demand exists for any one of the output objects displayed in the list; and
program code means for executing an individual display step of performing the individual display when it is judged in said individual demand judging step that the individual display demand exists.

8. A computer program product for controlling input/output of network office equipment according to claim 7, further comprising:
program code means for executing a delete demand step of accepting a delete demand for an arbitrary output object in the list; and
program code means for executing a delete step of deleting data of the output object stored in the network office equipment when the delete demand is accepted for the output object.

9. A system for controlling input/output of network office equipment, the system comprising a plurality of computers and a network office equipment to form a network,
wherein said network office equipment enables a list of output objects stored in said network office equipment to be displayed when receiving an output demand, and
wherein, when an output object is specified, said network office equipment judges whether or not the output object requires an authentication process, and allows the output object that is judged to require the authentication process to be outputted only when the authentication process is normally made.

10. A system for controlling input/output of network office equipment according to claim 9,
wherein said network office equipment, when receiving an output demand from said computer, transmits to said personal computer the list of the output objects stored in said network office equipment.

11. A system for controlling input/output of network office equipment according to claim 10,
wherein said network office equipment outputs to said computer data for display regarding the output object in the list specified by said computer so as to enable individual display of the specified output object in said computer in a form conforming to a demand from said computer.

12. A system for controlling input/output of network office equipment according to claim 9,
wherein, when an output demand is inputted from an operation section, said network office equipment displays the list of the output objects stored in said network office equipment.

13. A system for controlling input/output of network office equipment according to claim 12,
wherein said network office equipment performs individual display of the output object in the list specified by the operation section in the form conforming to a demand inputted from the operation section.

14. A system for controlling input/output of network office equipment according to claim 13,
wherein, when a delete demand is inputted from the operation section in the individual display, said network office equipment deletes data of the output object designated as the object of the individual display, which is stored in said network office equipment.

15. A network office equipment used in a system for controlling input/output of network office equipment, the system comprising a plurality of computers and the network office equipment to form a network,
wherein said network office equipment enables a list of output objects stored in said network office equipment to be displayed when receiving an output demand; and
wherein, when an output object is specified, said network office equipment judges whether or not the output object requires an authentication process and allows the output object that is judged to require the authentication process to be outputted only when the authentication process is normally made.

16. A network office equipment according to claim 15,
wherein, when the output demand is received from the computer connected to the network, the list of the output objects stored in the network office equipment is transmitted to said personal computer.

17. A network office equipment according to claim 16,
wherein data for display of the output object in the list specified by the computer connected to the network is outputted to the computer so as to enable individual display of the specified output object in the computer in a form conforming to a demand from the computer.

18. A network office equipment according to claim 15, comprising:
an operation section,
wherein, when an output demand is inputted from said operation section, the list of the output objects stored in said network office equipment is displayed.

19. A network office equipment according to claim 18,
wherein individual display of an output object in the list specified by said operation section is performed in a form conforming to a demand inputted from said operation section.

20. A network office equipment according to claim 19,
wherein, when a delete demand is inputted from said operation section in the individual display, data, which is stored in said network office equipment, of the output object designated as an individual display object is deleted.
